(19) United States
(12) Patent Application Publication
(10) Pub. No.: US 2023/0239138 A1
(43) Pub. Date: Jul. 27, 2023

(54) ENHANCED SECURE CRYPTOGRAPHIC COMMUNICATION SYSTEM

(71) Applicant: EVERYTHING BLOCKCHAIN TECHNOLOGY CORP., Jacksonville, FL (US)

(72) Inventors: Courtney Roach, Dover, FL (US); Brandon Hart, Dover, FL (US)

(73) Assignee: EVERYTHING BLOCKCHAIN TECHNOLOGY CORP., Jacksonville, FL (US)

(21) Appl. No.: 18/100,931

(22) Filed: Jan. 24, 2023

Related U.S. Application Data
(60) Provisional application No. 63/302,823, filed on Jan. 25, 2022.

(51) Int. Cl. H04L 9/08; H04L 9/30

(52) U.S. Cl. CPC H04L 9/0825; H04L 9/302

(57) ABSTRACT

In one form, a method for a client to conduct a secure communication with a server includes negotiating a selected cryptographic algorithm for use in a new session with the server. A new server public key and the selected cryptographic algorithm is received from the server a using a data payload signed by an embedded key pair. A new client key pair including a new client public key and a new client private key is generated using the selected cryptographic algorithm. The new client public key is sent to the server. At least one server data payload is received from the server during the new session encrypted by a new session key generated from the new client public key.

### BACKGROUND

Recently, reports of data breaches and compromises, thefts, or “hacks” of sensitive user information have become commonplace. Most of the vulnerabilities arise from exchange of user data over public networks, granting remote access to users whose security credentials or passwords can be guessed or automatically emulated, and storage and retrieval of data on systems that can be compromised. The industry has developed methods and algorithms for storing and transmitting data in encrypted format, such as the Advanced Encryption Standard (AES), which defines different block and key sizes and that provide higher levels of complexity for larger block and key sizes. A common AES standard, known as “AES-128”, can theoretically be discovered or hacked, although with a great amount of difficulty. While AES standards with higher computational complexity have been developed, many systems use legacy AES-128 encryption or even simpler encryption and are still vulnerable to attack.

A typical system using the public key infrastructure (PKI) algorithm uses a pair of cryptographic keys (public and private) to encrypt and decrypt data. In the PKI system, the public key is generally available and used to encrypt data, but the private key is kept confidential and can decrypt the data. Because the private key is stored on one or more devices, if the computer itself is breached or hacked and the private key is discovered, the computational complexity of deciphering PKI-encrypted data can be bypassed, and sensitive user data can be exposed.

Traditionally, a content provider receives a public and private key pair from an entity known as a Certificate Authority (CA). Any other user who wants to send an encrypted message can get the intended recipient's public key directly from the recipient or from a public directory. They use this key to encrypt the data, and send the encrypted data to the recipient. When the recipient gets the message, they decrypt it with their private key, which no one else should have access to. However in recent years, certificate authorities themselves have been hacked through various methods, exposing user's private keys and compromising sensitive user data. Moreover, as data processing systems have become more complex, more opportunities to intercept valuable data arise. One such case occurs when a private enterprise uses a “proxy server”. The proxy server obscures a user's identity, such as their internet protocol (IP) address, from visibility to the outside world. However, they can be breached from inside the organization as well, and the presence of proxy servers that buffer data increases the scope of a potential attack. What is needed is a technique that doesn't rely on trust of certificate authorities and intermediate agents during secure transactions and reduces the scope of a potential attack.

### BRIEF DESCRIPTION OF THE DRAWINGS

FIG. 1 illustrates an enhanced secure data processing system according to various embodiments disclosed herein;

FIG. 2 shows a data processing system with enhanced secure according to various embodiments described herein.

FIG. 3 illustrates a flow chart of a client performing an enhanced secure authentication method according to various embodiments described herein;

FIG. 4 illustrates a flow chart of a server performing an enhanced secure authentication method according to various embodiments described herein; and

FIG. 5 illustrates a block diagram of a data processing system having a non-transitory storage medium with instructions for performing the enhanced secure communication technique of FIG. 3 or FIG. 4 according to various embodiments disclosed herein.

In the following description, the use of the same reference numerals in different drawings indicates similar or identical items. Unless otherwise noted, the word “coupled” and its associated verb forms include both direct connection and indirect electrical connection by means known in the art, and unless otherwise noted any description of direct connection implies alternate embodiments using suitable forms of indirect electrical connection as well.

### DETAILED DESCRIPTION OF ILLUSTRATIVE EMBODIMENTS

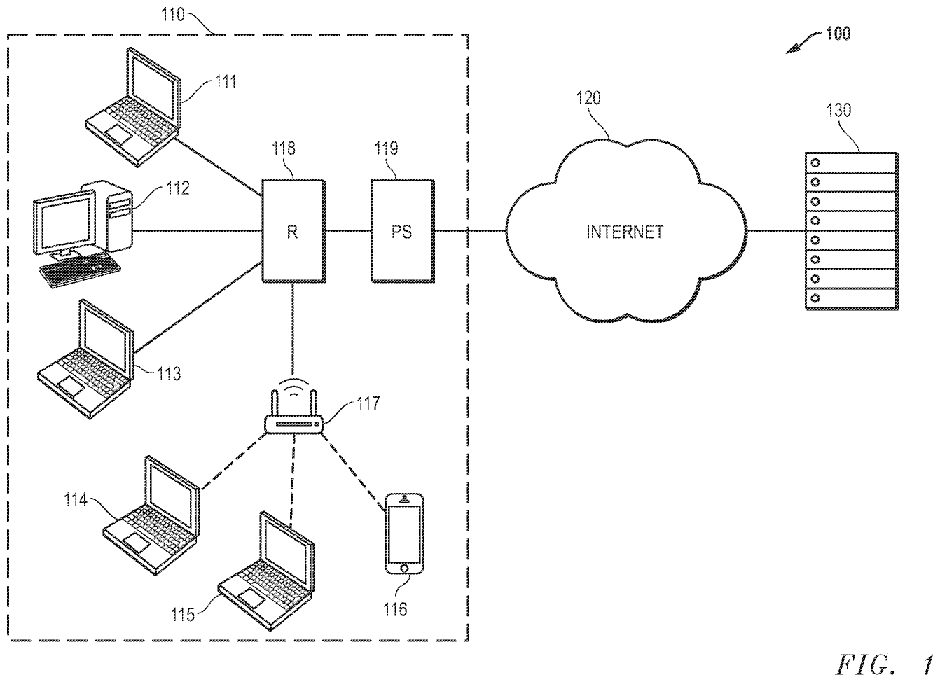

FIG. 1 illustrates a data processing system 100 according to various embodiments disclosed herein. Data processing system 100 includes generally a client network 110 of computing devices, a communication network 120 such as the Internet, and a content server 130.

Client network 110 includes generally a laptop computer 111, a desktop computer 112, laptop computers 113-115, a mobile phone 116, a wireless router 117, a wired router 118 labelled “R”, and a proxy server 119 labelled “PS”. Each of laptop computers 111 and 113 and desktop computer 112 is connected by corresponding cables to router 118. In one example, laptop computers 111 and 113 and desktop computer 112 communicate with router 118 using coaxial cable using the communication protocol known as “Ethernet”, corresponding to the Institute of Electrical and Electronics Engineers (IEEE) Standard 802.3. The cable can be coaxial or fiber-optic cables to provide high data bandwidth, such as 1 gigabit per second (1 Gbps.)

On the other hand, laptop computers 114 and 115 and mobile phone 116 communicate with wireless router 117 using a wireless standard known as “WiFi”, which is based on the IEEE 802.11 family of standards. Wireless router 117 itself has a further wired connection to router 118, for example using 1 Gbps Ethernet.

Router 118 in turn has a wired connection to proxy server 119. A proxy server is a server application that acts as an intermediary between a client requesting a resource and the server providing that resource. The client organization uses proxy server 119 to obscure the identities and IP addresses of each computer in client network 110 from the outside world to help prevent hacking of specific computers, targeting of computers from bad actors with malware, adware, spyware, denial-of-service attacks, and other malicious activity.

Proxy server 119 is connected to the Internet through, for example, an access point of an internet service provider (ISP). Content server 130 is connected to another access point of the same or a different ISP.

In operation, a user in client network 110, for example laptop computer 111, may desire to access certain content on the Internet such as that provided by content server 130. It does so typically by providing world wide web (www) address, and a domain name system (DNS) translates to an actual IP address. Since the Internet is a public network, both the client (laptop computer 111) and content server 130 preferably encrypt their transactions. The do so generally using the PKI. Using PKI security protocols, laptop computer 111 verifies the validity of the signature of the certificate of content server 130, and obtains the content server's public key. Once it receives content server 130's public key, it can use the public key to encrypt data, requiring content server 130 to use its private key to decrypt the transmission.

According to various embodiments disclosed herein, instead of relying on public keys issued by CAs for data encryption, data processing system 100 generates new public/private key pairs for use during only a particular communication session, and that are valid only during that session. When the session ends, the client and content server each quickly destroy their respective keys. Thus, a breach of a CA that may lead to exposure and discovery of content server 130's private keys would not affect the cryptographic integrity of the messages exchanged thereby during any particular session. Moreover, even the discovery of a private key used during a session would limit the exposure to the data exchanged and captured while the session is active. Thus, the enhanced secure authentication technique significantly limits the scope of loss as a result of any breach.

The authentication and dispatch of keys during a new session will now be described.

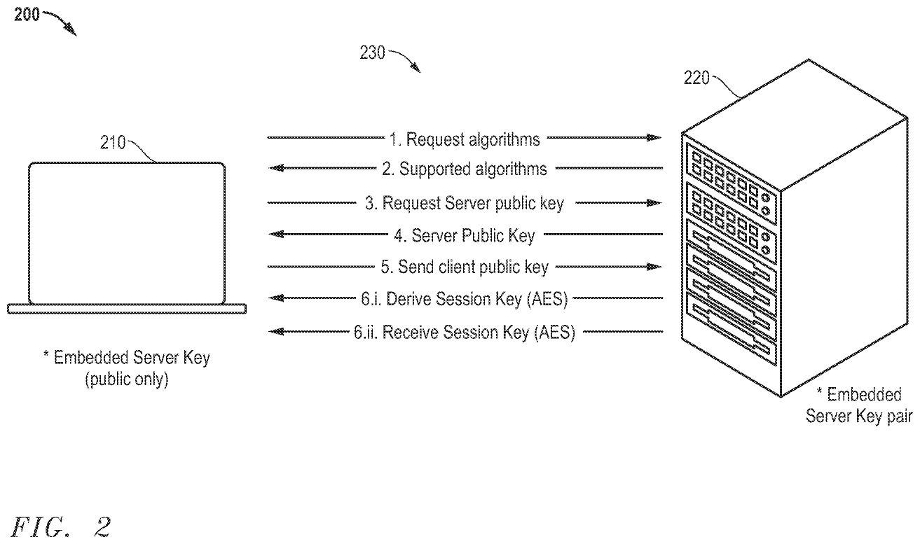

FIG. 2 shows a data processing system 200 with enhanced secure cryptography according to various embodiments described herein. Data processing system 200 defines two roles, that of a client 210 and that of a server 220. Client 210 establishes a new session with server 220 using a series of operations forming a method 230 that will now be described.

In step 1, client 210 “asks” or queries server 220 to determine which asymmetric algorithms it current supports, such as Elliptic-Curve Cryptography (ECC), Rivest—Shamir—Adleman (RSA), variations of ECC or RSA with different key lengths, etc. This system of client and server comparison and evaluation allows server 220 to add or deprecate algorithms over time as cryptography evolves.

In step 2, server 220 responds with its currently supported algorithms. The response can identify the supported encryption algorithms either directly by character strings, or indirectly by codes corresponding to the supported algorithms, sending a codeword with bits corresponding to supported algorithms set while bits corresponding to unsupported algorithms are cleared, etc.

In step 3, client 210 compiles a list of algorithms it can support and compares this list to the list returned by server 220. This step ensures that client 210 doesn't start a session it cannot utilize, i.e., client 210 will not start a session if server 220 only supports encryption algorithms that client 210 does not support. If client 210 supports at least one algorithm supported by server 220, then client 210 requests a new unique server public key by sending a list of algorithms that client 210 itself can support.

In step 3, server 220 receives the request by client 210 for a new server public key. Typically, both client 210 and server 220 would be able to support multiple algorithms. These algorithms include ECC, RSA, and various key lengths for each. Server 220 chooses an algorithm based on priority, such as according to cryptographic strength. For example, ECC is stronger than RSA and would take priority over RSA; and RSA-2048 is stronger than RSA-1024 and would take priority over RSA-1024. Server 220 then generates a new key pair, storing the private key for its future use while also sending the public key to the client 210. This response payload will be signed using server 220's embedded key pair.

In step 4, client 210 receives server 220's public key and the cryptographic algorithm type. Client 210 uses the local embedded server public key to verify the signature of the payload. This verification ensures the payload is in fact from the correct server and has not been altered during transmission.

In step 5, client 210 generates its own key pair using the algorithm that server 220 judges to be the highest priority. Client 210 sends its own public key to server 220.

In step 6, the symmetrical key (AES session key) is created, and the creation and exchange of the session key varies depending on the selected algorithm. If server 220 selects ECC, then in step 6.i it uses the Elliptic Curve Diffie-Hellman (ECDH) algorithm, which allows both parties, client 210 and server 220, to derive the same AES key using a combination of their private key and the other entity's public key. If server 220 selects RSA, then in step 6.ii it generates a session AES key, encrypts it using client 210's public key, and returns it to client 210. Client 210 decrypts the AES session key using its private RSA key.

After exchanging these keys as described in steps 1-6, client 210 and server 220 exchange data payloads using the new keys generated for this session. They use these keys for the duration of the session, and destroy them securely at the end of the session. For example, client 210 and server 220 overwrite their values using, e.g., a digital shredder, since files deleted from the computer's directory may continue to exist and be detectable on a storage medium such as a hard disk drive or non-volatile memory for some time in the future.

By using this enhanced secure cryptographic technique, client 210 and server 220 minimize the scope of loss caused by an attack. Moreover, the enhanced secure cryptographic technique mitigates the added vulnerability caused by routing communications through routers and proxy servers, e.g., on the client organization's premises. It also moves computer networking one step closer to the ultimate goal of end-to-end zero trust.

The actions of client 210 and server 220 will now be explored separately and in greater detail.

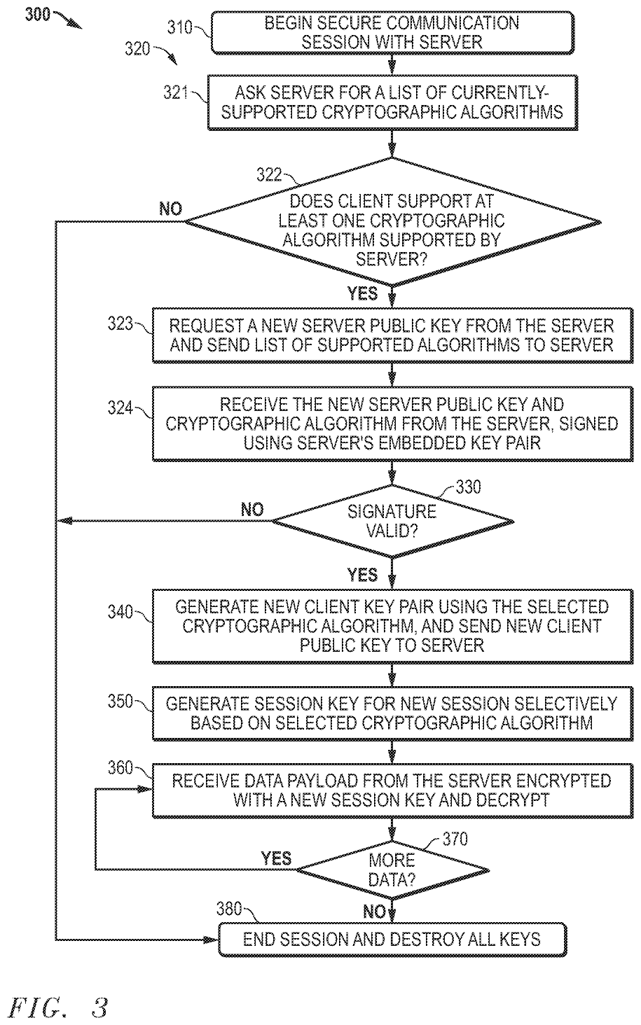

FIG. 3 illustrates a flow chart of a method 300 of a client such as client 210 of FIG. 2 performing an enhanced secure authentication method according to various embodiments described herein. Method 300 begins with an action box 310 in which a client desires to begin a session with a server. For example, a user may access content on server 220 either directly or indirectly through a DNS access. In a series of actions 320, client 210 begins the process of starting a remote session with a server.

In an action box 321, client 210 asks (queries) server 220 for a list of currently-supported cryptographic algorithms. In a decision box 322, client 210 determines whether it supports at least on cryptographic algorithm supported by server 220. For example, some clients may only support RSA-1024, but server 220 operates with especially sensitive data and has already deprecated RSA-1024. If client 210 does not supports at least one algorithm currently supported by server 220, then flow proceeds to box 380, at which it ends the session and destroys all keys generated during the session. If client 210 supports at least one algorithm currently supported by server 220, then flow continues to an action box 323. In action box 323, client 210 requests a new server public key from server 220 and sends its list of supported algorithms to server 220. By evaluating the congruence of supported cryptographic techniques with server 220, client 210 ensures that it does not start a session it cannot utilize. In an action box 324, client 210 receives the new server public key and the cryptographic algorithm selected by server 220, in which this information is signed by the server's embedded key pair. This additional signature helps prevent an entity that is intercepting communications and is not server 220 does not trick client 210 into divulging sensitive data.

In a decision box 330, client 210 evaluates whether the signature is valid using know techniques. If the certificate is not valid, then client 210 proceeds to box 380 and ends the session. If however it determines that the received signature is valid, then it continues to an action box 340.

In action box 340, client 210 generates a new client key pair using the selected cryptographic algorithm, i.e., the algorithm selected by server 220. Then it sends the new client public key to server 220 to allow it to encrypt data it sends to client 210.

In an action box 350, client 210 generates a session key for the new session selectively based on the selected cryptographic algorithm. As explained above, if ECC is selected, then client 210 generates the AES session key using server 220's public key and its private key. On the other hand if RSA is selected, then server 220 will generate the session AES key, encrypt it using client 210's public key, and return it to client 210. Client 210 then can decrypt it using its private RSA key.

In an action box 360, client 210 exchanges data with server 220. For example, client 210 receives a data payload from server 220 encrypted using the new session key, and decrypts it using the AES session key created according to the selected cryptographic algorithm as described above in in action box 350.

In decision box 370, client 210 evaluates whether there is more data to be sent or received as part of the session. If so, then flow returns to action box 360. If not, then flow continued to box 380, and client 210 ends the session and destroys all keys. If client 210 subsequently establishes another communication with server 220, then it creates new session keys as described above. This technique prevents the session keys from being active for more than the length of time it takes to complete the session, and does not use a key pair maintained by a certificate authority except for a few steps at the beginning of the session before actual payload data is exchanged. Thus, this technique minimizes the period of time the keys are exposed and therefore the scope of any possible attack.

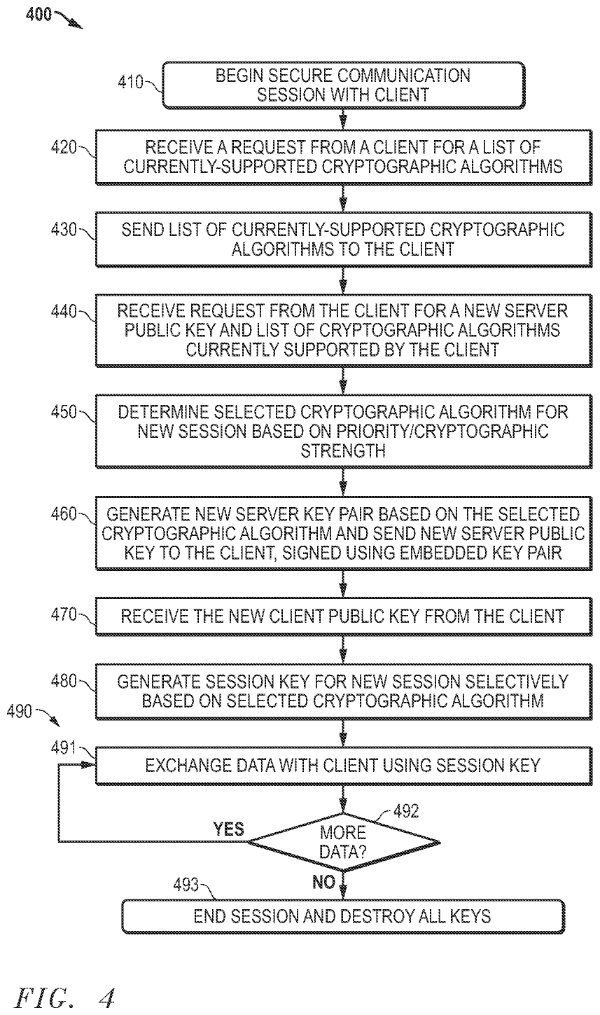

FIG. 4 illustrates a flow chart of a method 400 of a server such as server 220 of FIG. 2 performing an enhanced secure authentication method according to various embodiments described herein. Method 400 begins with an action box 410 in which a server begins a communication session with a client such as client 210 of FIG. 1.

In an action box 420, server 220 receives a request from a client such as client 210 for a list of currently-supported cryptographic algorithms. At a particular point in time, server 220 may support some cryptographic algorithms, but at a later point in time it may deprecate or remove some algorithms from support. For example, if someone publishes a technique to defeat a particular cryptographic technique, then server 220 would deprecate that technique to prevent exposing sensitive data.

In an action box 430, server 220 sends a list of cryptographic algorithms it supports to the client. As pointed out above, this preview of server-supported algorithms allows the client to determine whether it does not support any algorithms currently supports by the server, and to avoid starting a session.

In an action box 440, server 220 receives a request from client 210 for a new server public key and for the list of cryptographic algorithms currently supports by the client.

In an action box 450, server 220 determines the selected cryptographic algorithm to be used in the new session in response to the client request in action box 440. In general, server 220 selects the selected cryptographic algorithm based on a priority among the algorithms commonly supported by both server 220 and client 210. In particular embodiments, server 220 determined the priority according to the relative cryptographic strength. For example, ECC is considered to have more cryptographic strength than RSA, so server 220 would select ECC as the selected cryptographic algorithm if both client 210 and server 220 support both RSA and ECC. Moreover, RSA-2048 is considered to have more cryptographic strength than RSA-1024 because the longer key length would require significantly more processing speed and time to crack.

In an action box 460, server 220 generates a new server key pair based on the selected cryptographic algorithm. It sends the new server public key to client 210 by signing it using its embedded key pair.

In an action box 470, server 220 receives the new client public key for the session.

In an action box 480, server 220 generates session keys for a new session selectively based on the selected cryptographic algorithm. If ECC is selected, then server 220 generates the AES session key using client 210's public key and its private key. On the other hand if RSA is selected, then server 220 will generate the session AES key, encrypt it using client 210's public key, and return it to client 210, allowing client 210 to decrypt it using its own private RSA key.

In a sub-flow 490, server 220 exchanges data for the session. In an action box 491, server 220 exchanges data with client 210. For example, server 220 sends a data payload from to client 210 encrypted using the new session key, allowing client 210 to decrypt it using the AES session key created according to the selected cryptographic algorithm as described above. In decision box 492, server 220 evaluates whether there is more data to be sent or received as part of the session. If so, then flow returns to action box 491. If not, then flow continues to box 493, and server 220 ends the session and destroys all keys. If server 220 subsequently establishes another communication with client 210, then it creates new session keys as described above. This technique prevents the session keys from being active for more than the length of time it takes to complete the session, and does not use a key pair maintained by a certificate authority except for a few steps at the beginning of the session before actual payload data is exchanged. Thus, this technique minimizes the period of time the keys are exposed and therefore the scope of any possible attack.

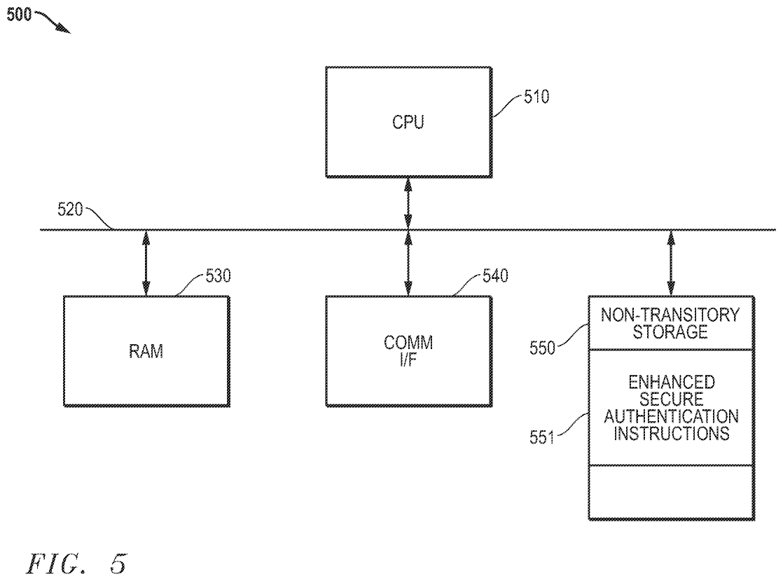

FIG. 5 illustrates a block diagram of a data processing system 500 having a non-transitory storage medium with instructions for performing the enhanced secure communication technique of FIG. 3 or FIG. 4 according to various embodiments disclosed herein. Data processing system 500 includes generally a processor 510 labelled “CPU” connected to a bus 520, a volatile memory 530, a communication interface circuit 540 labelled “COMM I/F”, and a non-transitory storage medium 550.

In the example shown in FIG. 5, volatile memory 530 is a random-access memory and thus volatile memory 530 is labeled “RAM”. Volatile memory 530 is a high-speed memory that stores application programs and data so they can be accessed by processor 510 at high speed. Communication interface circuit 540 is representative of a set of communication protocols that are supported by data processing system 500. For example, if data processing system 500 were a laptop computer, then communication interface circuit 540 could include universal serial bus (USB) controllers, data link controllers such as IEEE 802.11 (WiFi) controllers, and the like. If data processing system 500 were a desktop computer, then communication interface circuit 540 could include universal serial bus (USB) controllers, data link controllers such as IEEE 802.3 (Ethernet) controllers, and the like. If data processing system 500 were a server, then communication interface circuit 540 could include inter-processor controllers, and the like.

Non-transitory computer-readable medium 550 includes storage that maintains its state even when powered off. It can include a hard-disk driver (HDD), a solid-state drive, a FLASH memory, a remote memory such as a cloud storage drive, and the like. It can be used to store enhanced secure authentication instructions to perform the techniques and methods described herein. In some embodiments, the enhanced secure authentication instructions form a stand-alone program that is invoked by the user. In other embodiments, the enhanced secure authentication instructions are part of the communication driver for one of the communications interface controllers. In still other embodiments, the enhanced secure authentication instructions implement an application programming interface (API) that is available to communication software used in data processing system 500. In this example, the enhanced secure authentication instructions may further access library functions available under the data processing system's main operating system to implement the cryptographic operations described herein.

While various embodiments have been described, it should be apparent that various modifications may exist. For example, the enhanced secure communication technique described herein can be used with a variety of different cryptographic algorithms. While ECC and RSA were described, the techniques are not limited to those algorithms and contemplate algorithms to be developed in the future. The techniques are robust because algorithms can later be added to the existing algorithms that are supported by the server as they are developed an introduced, while other algorithms can be deprecated and removed from the list of supported algorithms if they are cracked or if they fall into disuse.

Accordingly, it is intended by the appended claims to cover all modifications that fall within the scope of the disclosed embodiments.

### Glossary

The following terms and acronyms are used herein and have the following meanings:
AES: Advanced Encryption Standard
CA: Certificate Authority
DNS: Domain Name System
ECC: Elliptic-Curve Cryptography
ISP: Internet Service Provider
PKI: Public Key Infrastructure
PS: Proxy Server
RSA: Rivest—Shamir—Adleman (RSA) cryptographic algorithm

What is claimed is:

1. A method for conducting a secure communication between a client and a server, comprising:
negotiating, between the client and the server, a selected cryptographic algorithm for use in a new session;
requesting, by the client, a new server public key from the server for use in the new session;
creating, by the server, a new server key pair using the selected cryptographic algorithm in response to the requesting, the new server key pair including the new server public key and a new server private key;
sending, by the server, the new server public key and the selected cryptographic algorithm to the client;
generating, by the client, a new client key pair using the selected cryptographic algorithm, the new client key pair including a new client public key and a new client private key, and sending the new client public key to the server;
sending, by the client, the new client public key to the server;
creating a new AES session key based on creating the new server key pair and creating the new client key pair; and
transferring at least one data payload during the new session encrypted by the new AES session key.

2. The method of claim 1, further comprising:
destroying the new server key pair by the server in response to an end of the new session; and
destroying the new client key pair by the client in response to the end of the new session.

3. The method of claim 1, wherein sending by the server the new server public key to the client comprises:
sending the new server public key using a data payload signed by an embedded key pair.

4. The method of claim 1, wherein the negotiating comprises:
exchanging, by the client and the server, respective lists of currently supported cryptographic algorithms; and
choosing, by the server, the selected cryptographic algorithm based on at least one cryptographic algorithm commonly supported by both the client and the server.

5. The method of claim 1, further comprising:
subsequently creating the new AES session key for communications between the client and the server selectively based on the selected cryptographic algorithm.

6. The method of claim 5, wherein in response to the selected cryptographic algorithm being elliptic-curve cryptography (ECC), the method further comprises:
generating, by the client, a common session key using a combination of the new client private key and the new server public key.
generating, by the server, the common session key using a combination of the new server private key and the new client public key.

7. The method of claim 5, wherein in response to the selected cryptographic algorithm being Rivest-Shamir-Adelman (RSA) cryptography, the method further comprises:
generating, by the server, the new AES session key;
encrypting, by the server, the new AES session key using the new client public key to form an encrypted AES session key;
returning, by the server, the encrypted AES session key to the client; and
decrypting, by the client, the encrypted AES session key using the new client private key.

8. The method of claim 1, wherein choosing, by the server, the selected cryptographic algorithm comprises:
choosing the selected cryptographic algorithm based on cryptographic strength.

9. A method for a client to conduct a secure communication with a server, comprising:
negotiating a selected cryptographic algorithm for use in a new session with the server;
receiving from the server a new server public key and the selected cryptographic algorithm using a data payload signed by an embedded key pair;
generating a new client key pair including a new client public key and a new client private key using the selected cryptographic algorithm;
sending the new client public key to the server; and
receiving at least one server data payload from the server during the new session encrypted by a new session key generated from the new client public key.

10. The method of claim 9, further comprising:
destroying the new client key pair by the client in response to an end of the new session.

11. The method of claim 9, wherein negotiating the selected cryptographic algorithm comprises:
asking the server for a list of cryptographic algorithms the server currently supports;
receiving a first list of cryptographic algorithms currently supported by the server if the client and the server support at least one cryptographic algorithm in common:
requesting the new server public key and sending a second list of cryptographic algorithms currently supported by the client; and
receiving the selected cryptographic algorithm and the new server public key from the server.

12. The method of claim 9, wherein the selected cryptographic algorithm is elliptic-curve cryptography (ECC).

13. The method of claim 12, wherein the method further comprises:
generating the new session key from the new server public key and the new client private key; and
receiving at least one data payload from the server; and
decrypting the at least one data payload using the new session key.

14. The method of claim 9, wherein the selected cryptographic algorithm is Rivest-Shamir-Adelman (RSA) cryptography, and the method further comprises:
receiving an encrypted session key from the server; and
decrypting the encrypted session key using the new client private key.

15. The method of claim 14, further comprising:
receiving at least one data payload from the server encrypted using the new client public key.

16. A method for a server to conduct a secure communication with a client, comprising:
negotiating a selected cryptographic algorithm for use in a new session with the client;
generating a new server key pair comprising a new server public key and a new server private key using the selected cryptographic algorithm;
sending the new server public key and the selected cryptographic algorithm to the client using a data payload signed by an embedded key pair;
receiving a new client public key;
creating a new session key generated using the new client public key;
encrypting the new session key using the new client public key, thereby forming an encrypted session key; and
subsequently sending at least one additional data payload to the client during the new session encrypted by the new session key.

17. The method of claim 16, further comprising:
destroying the new server key pair by the server in response to an end of the new session.

18. The method of claim 16, wherein negotiating with the client the selected cryptographic algorithm for use in the new session comprises:
sending a first list of cryptographic algorithms currently supported by the server to the client;
receiving a second list of cryptographic algorithms currently supported by the client and a request for the new server public key from the client; and
choosing the selected cryptographic algorithm based on at least one cryptographic algorithm commonly supported by both the client and the server.

19. The method of claim 18, wherein choosing the selected cryptographic algorithm comprises:
choosing the selected cryptographic algorithm based on cryptographic strength.

20. The method of claim 16, wherein the selected cryptographic algorithm is elliptic-curve cryptography (ECC), and the method further comprises:
generating the new session key from the new client public key and the new server private key.

21. The method of claim 16, wherein the selected cryptographic algorithm is Rivest-Shamir-Adelman (RSA) cryptography, and the method further comprises:
generating the new session key;
encrypt the new session key using the new client public key to form the encrypted session key; and
send the encrypted session key to the client.

22. A non-transitory computer-readable medium comprising instructions that, when provided to and executed by a processor associated with a client cause the processor to:
negotiate a selected cryptographic algorithm for use in a new session with a server;
receive from the server a new server public key and the selected cryptographic algorithm using a data payload signed by an embedded key pair;
generate a new client key pair including a new client public key and a new client private key using the selected cryptographic algorithm;
send the new client public key to the server; and
receive at least one server data payload from the server during the new session encrypted by a new session key generated from the new client public key.

23. The non-transitory computer-readable medium of claim 22, wherein the instructions further cause the processor to:
destroy the new client key pair by the client in response to an end of the new session.

24. The non-transitory computer-readable medium of claim 22, wherein the instructions cause the processor to negotiate the selected cryptographic algorithm further by:
asking the server for a list of cryptographic algorithms the server currently supports;
receiving a first list of cryptographic algorithms currently supported by the server if the client and the server support at least one cryptographic algorithm in common:
requesting the new server public key and sending a second list of cryptographic algorithms currently supported by the client; and
receiving the selected cryptographic algorithm and the new server public key from the server.

25. The non-transitory computer-readable medium of claim 22, wherein the instructions further cause the processor to:
receive at least one data payload from the server encrypted using the new client public key.

26. A non-transitory computer-readable medium comprising instructions that, when provided to and executed by a processor associated with a server cause the processor to:
negotiate a selected cryptographic algorithm for use in a new session with a client;
generate a new server key pair comprising a new server public key and a new server private key using the selected cryptographic algorithm;
send the new server public key and the selected cryptographic algorithm to the client using a data payload signed by an embedded key pair;
receive a new client public key;
create a new session key generated using the new client public key;
encrypt the new session key using the new client public key, thereby forming an encrypted session key; and
subsequently send at least one additional data payload to the client during the new session encrypted by the new session key.

27. The non-transitory computer-readable medium of claim 26, wherein the instructions further cause the processor to:
destroy the new server key pair in response to an end of the new session.

28. The non-transitory computer-readable medium of claim 26, wherein the instructions further cause the processor to:
send a first list of cryptographic algorithms currently supported by the server to the client;
receive a second list of cryptographic algorithms currently supported by the client and a request for the new server public key from the client; and
choose the selected cryptographic algorithm based on at least one cryptographic algorithm commonly supported by both the client and the server.

29. The non-transitory computer-readable medium of claim 28, the instructions further cause the processor to choose the selected cryptographic algorithm by:
choosing the selected cryptographic algorithm based on cryptographic strength.
